(19) United States
(12) Patent Application Publication
(10) Pub. No.: US 2024/0254418 A1
(43) Pub. Date: Aug. 1, 2024

(54) PROCESS OF MANUFACTURING A LIQUID BEER CONCENTRATE

(71) Applicant: Heineken Supply Chain B.V., Zoeterwoude (NL)

(72) Inventors: Eric Richard Brouwer, Zoeterwoude (NL); Augustinus Cornelius Aldegonde Petrus Albert Bekkers, Zoeterwoude (NL)

(73) Assignee: Heineken Supply Chain B.V., Zoeterwoude (NL)

(21) Appl. No.: 18/432,959

(22) Filed: Feb. 5, 2024

Related U.S. Application Data
(63) Continuation of application No. PCT/EP2022/071818, filed on Aug. 3, 2022.

(30) Foreign Application Priority Data
Aug. 3, 2021 (EP) 21189316.9

(51) Int. Cl. C12C 11/11; B01D 61/02; B01D 61/04; B67C 3/02; C12C 12/00; C12H 3/00

(52) U.S. Cl. CPC C12C 11/11; B01D 61/025; B01D 61/04; B67C 3/02; C12C 12/00; C12H 3/00; B01D 2311/04

(57) ABSTRACT

The present invention relates to a process of manufacturing a liquid alcoholic beer concentrate, said process comprising:
providing a low alcohol beer having an ethanol content of 0-1% ABV, a free amino nitrogen content of 8-400 mg/L and containing 0.1-4 g/L maltotriose and 0.5-6 g/L of maltotetraose;
removing at least 70 wt. % of the water present in the low alcohol beer by means of membrane separation to produce a low alcohol beer concentrate, wherein the membrane separation is selected from nanofiltration, reverse osmosis and forward osmosis;
combining the low alcohol beer concentrate with alcoholic liquid having an ethanol content of at least 30 wt. % to produce a liquid alcoholic beer concentrate having a an ethanol content of 10-60 wt. %.

The present process offers the advantage that it is relatively easy to operate, whilst at the same time losses of small organic molecules (e.g. acids) are minimized effectively.

### CROSS-REFERENCE TO RELATED APPLICATIONS

This application is a continuation of International Patent Application No. PCT/EP2022/071818 filed Aug. 3, 2022, which application claims priority to Netherlands Patent Application No. 21189316.9 filed Aug. 3, 2021, the contents of which are both incorporated herein by reference in their entireties.

### TECHNICAL FIELD OF THE INVENTION

The present invention relates to a process of manufacturing a liquid alcoholic beer concentrate, said process comprising:
providing a low alcohol beer having an ethanol content of 0-1% ABV, a free amino nitrogen content of 8-400 mg/L and containing 0.1-4 g/L maltotriose and 0.5-6 g/L of maltotetraose;
removing at least 70 wt. % of the water present in the low alcohol beer by means of membrane separation to produce a low alcohol beer concentrate, wherein the membrane separation is selected from nanofiltration, reverse osmosis and forward osmosis;
combining the low alcohol beer concentrate with alcoholic liquid having an ethanol content of at least 30 wt. % to produce a liquid alcoholic beer concentrate having an ethanol content of 10-60 wt. %.

The invention also relates to a liquid beer concentrate that is obtained by the aforementioned process.

### BACKGROUND OF THE INVENTION

The popularity of domestic appliances for preparing and dispensing carbonated beverages from concentrated syrup, such as Sodastream®, has grown rapidly. These appliances produce carbonated beverages by carbonating water and mixing the carbonated water with a flavoured syrup. Given the high flexibility and convenience provided by these appliances, it would be desirable to have available beer concentrates from which beer can be produced using similar appliances.

Since beer typically contains more than 90% of water, beer can be concentrated considerably by removing most of the water. The benefits of producing beer from a concentrate have been recognized in the art. However, the production of a beer concentrate that can suitably be used to produce a good quality beer represents a challenging task.

First of all, water should be removed selectively so as to avoid loss of flavour substances, color and/or beer components that contribute to the formation and stability of foam heads. Furthermore, during water removal precipitation of solutes (e.g. proteins, sugars) should be avoided.

U.S. Pat. No. 4,265,920 describes a process for the concentration of aqueous alcoholic beverage solutions, containing in addition to non-volatile components, alcohol and small amounts of volatile aroma components by the selective removal of water, comprising the following steps:
(a) a first step in which substantially all of the alcohol and the more volatile aroma components are separated by a process of distillation at strongly reduced pressure, from the bulk of the aqueous solution and in which the vapors containing alcohol and more volatile aroma components obtained by said distillation process are condensed in a condenser,
(b) a second step in which the aqueous solution obtained in step (a), is concentrated by removing water in a process of freeze concentration while retaining in the solution the aroma components remaining from step a), and
(c) a third step in which the condensate containing alcohol and more volatile aroma components obtained in step (a), is mixed with the concentrate obtained in step (b).

WO 2016/083482 describes a method for preparing beer concentrate, comprising the steps of:
a) subjecting beer or cider (1) to a first concentration step comprising nanofiltration (A) or reverse osmosis to obtain a retentate (2) and a fraction comprising alcohol and volatile flavour components (3), wherein the retentate (2) is characterised by the concentration of unfilterable compounds equal to or higher than 20% (w/w), as calculated from density measurement corrected for the alcohol amount;
b) subjecting the fraction comprising alcohol and volatile flavour components (3) to a next concentration step (B) comprising freeze concentration, fractionation, preferably being distillation, or reverse osmosis, to obtain a concentrated fraction comprising alcohol and volatile flavour components (4) and a leftover fraction (5);
c) combining (C) the retentate (2) from a) with the concentrated fraction (4) comprising alcohol and volatile flavour components from b).

WO 2018/134285 describes a method for preparing a concentrate comprising the steps of
A) subjecting beer or cider (1) to a first concentration step to obtain a retentate (2) and a permeate (3) comprising alcohol (3a) and volatile flavour components (3b),
B) subjecting the permeate (3) to an adsorption step whereby the volatile flavour and alcohol containing permeate is passed over or through an adsorption unit,
C) recovering the flavour components (3b) from the adsorption unit in a further recuperation process
D) combining the retentate (2) with the flavour components (3b).

US 2016/230133 describes a method of preparing a concentrate from an alcoholic beverage, comprising:
subjecting an alcoholic beverage to a membrane process by which at least some water and alcohol pass through a membrane to be part of a permeate and other components of the alcoholic beverage do not pass through the membrane and are part of a retentate;
freezing water in the retentate to form ice; and
removing ice from the retentate to reduce water content and form a beverage concentrate having a solids concentration of at least 30% and an alcohol concentration of 20% or less.

### SUMMARY OF THE INVENTION

The inventors have developed a process for the manufacture of liquid alcoholic beer concentrates in which a low alcohol beer is subjected to membrane separation to produce a low alcohol beer concentrate, which low alcohol beer concentrate is subsequently combined with alcoholic liquid to produce the liquid alcoholic beer concentrate.

More particularly, the present invention relates to a process of manufacturing a liquid alcoholic beer concentrate, said process comprising:
providing a low alcohol beer having an ethanol content of 0-1% ABV, a free amino nitrogen content of 8-400 mg/L and containing 0.1-4 g/L maltotriose and 0.5-6 g/L of maltotetraose;
removing at least 70 wt. % of the water present in the low alcohol beer by means of membrane separation to produce a low alcohol beer concentrate, wherein the membrane separation is selected from nanofiltration, reverse osmosis and forward osmosis;
combining the low alcohol beer concentrate with alcoholic liquid having an ethanol content of at least 30 wt. % to produce a liquid alcoholic beer concentrate having an ethanol content of 10-60 wt. %.

The membranes used in nanofiltration, reverse osmosis and forward osmosis retain virtually all components of the low alcohol beer, except for water and possibly monovalent ions and very small organic molecules. Thus, membrane separation offers the advantage that components that are important to the taste, mouthfeel and stability of the beer are effectively retained in the low alcohol beer concentrate.

Due to the fact that in the present process low alcohol beer is subjected to membrane separation, it is not necessary to employ a membrane that retains virtually all ethanol, as is required when reverse osmosis is used to produce an alcoholic beer concentrate in a single step. The present process also does not require the use of membranes with a cut-off that allows most ethanol to pass through the membrane, as is required when nanofiltration is used to produce a low alcohol beer concentrate and an alcohol containing permeate.

As a result, the membrane separation step of the present process is relatively easy to operate, whilst at the same time losses of small organic molecules (e.g. acids) are minimised effectively.

The invention further relates to a liquid alcoholic beer concentrate that is obtained by the aforementioned process.

### FIGURES

FIG. 1 provides a schematic representation of a method of preparing a single-serve capsule containing a liquid alcoholic beer concentrate according to the invention.

FIG. 2 shows a representation of a beverage preparation device that contains a single serve capsule according to the invention.

FIG. 3 shows a representation of a nanofiltration device as used according to the invention.

### DETAILED DESCRIPTION OF THE INVENTION

Thus, one aspect of the present invention concerns a process of manufacturing a liquid alcoholic beer concentrate, said process comprising:
providing a lows alcohol beer having an ethanol content of 0-1% ABV;
removing at least 70 wt. % of the water present in the low alcohol beer by means of membrane separation to produce a low alcohol beer concentrate, wherein the membrane separation is selected from nanofiltration, reverse osmosis and forward osmosis;
combining the low alcohol beer concentrate with alcoholic liquid having an ethanol content of at least 30 wt. % to produce a liquid alcoholic beer concentrate having an ethanol content of 10-60 wt. %.

The term “beer” as used herein refers to a yeast fermented malt beverage that has optionally been hopped. Beer is commonly produced by a process that comprises the following basic steps:
mashing a mixture comprising malted barley, optionally supplementary grains and water to produce a mash;
separating the mash in wort and spent grains;
boiling the wort to produce a boiled wort;
fermenting the boiled wort with live yeast to produce a fermented wort;
subjecting the fermented wort to one or more further process steps (e.g. maturation and filtration) to produce beer; and
packaging the beer in a sealed container, e.g. a bottle, can or keg.

Hop or hop extract can be added during wort boiling to impart bitterness and floral, fruity flavor notes to the beer.

The term “beer concentrate” as used herein refers to beer from which water has been removed, e.g. by means of nanofiltration, reverse osmosis, forward osmosis.

The term “membrane separation” as used herein refers to a separation method in which molecules are separated by passing a feed stream through a membrane that separates it into two individual streams, known as the permeate and the retentate. Examples of membrane separation include nanofiltration, reverse osmosis and forward osmosis.

The term “distillation” as used herein refers to the removal of ethanol by boiling the low alcohol beer and by collecting the evaporated components after condensation. The term “distillation” encompasses vacuum distillation as well as osmotic distillation.

The term “capsule” as used herein refers to a compartmentalized container suitable for separately holding the two liquid components according to the invention.

The term “single-serve” as used herein is a synonym of “monoportion” or “unit dose” and refers to a capsule comprising sufficient amounts of beer concentrate and alcoholic liquid to prepare one serving of reconstituted beer. Typically, one serving of reconstituted beer is in the range of 120 ml to 1000 ml.

The term “free amino nitrogen” as used herein refers to the combined concentration of individual amino acids and small peptides as determined by EBC method 9.10.1—Free Amino Nitrogen in Beer by Spectrophotometry (IM).

Concentrations of acids as mentioned herein, unless indicated otherwise, also include dissolved salts of these acids as well as dissociated forms of these same acids and salts.

The term “iso-alpha acids” as used herein refers to substances selected from the group of isohumulone, isoadhumulone, isocohumulone, pre-isohumulone, post-isohumulone and combinations thereof. The term “iso-alpha acids” encompasses different stereo-isomers (cis-iso-alpha acids and trans-iso-alpha acids). Iso-alpha acids are typically produced in beer from the addition of hops to the boiling wort. They may also be introduced into the beer in the form of pre-isomerised hop extract. Iso-alpha-acids are intensely bitter with an estimated threshold value in water of approximately 6 ppm.

The term “hydrogenated iso-alpha acids” refers to substances selected from dihydro-iso-alpha acids, tetrahydro-isoalpha acids, hexahydro-iso-alpha acid and combinations thereof.

The term “hulupones” as used herein refers to substances selected from cohulupone, n-hulupone, adhulupone and combinations thereof. Hulupones are oxidation products of hop beta-acids.

The low alcohol beer that is subjected to membrane separation in the present process preferably has an ethanol content of 0-0.5% ABV, more preferably of 0-0.3% ABV, even more preferably of 0-0.1% ABV and most preferably of 0-0.05% ABV.

The low alcohol beer that is employed in the present process typically contains sugars, proteins, peptides, amino acids, riboflavin, free fatty acids and volatile flavour substances such as ethyl acetate, isoamyl acetate, phenylethyl acetate and acetaldehyde.

The riboflavin content of the low alcohol beer is preferably in the range of 40-1,000 μg/L more preferably 60-800 μg/L and most preferably 100-600 μg/L.

The low alcohol beer preferably contain 20-1,500 μg/L, more preferably 40-1,200 μg/L and most preferably 50-800 μg/L of linoleic acid.

Besides linoleic acid, the low alcohol beer typically also contains other fatty acids, such as oleic acid and/or alpha-linolenic acids. Oleic acid is preferably present in the low alcohol beer in a concentration of 60-900 μg/L, more preferably 80-700 μg/L, most preferably 100-600 μg/L.

Alpha-linolenic acid is preferably present in the low alcohol beer in a concentration of 20-800 μg/L, more preferably 40-600 μg/L, most preferably 50-500 μg/L.

The free amino nitrogen (FAN) content of the low alcohol beer is preferably in the range of 8-400 mg/L more preferably 12-300 mg/L, most preferably in the range of 20-250 mg/L.

The low alcohol beer preferably contains 0.5-6 g/L, more preferably 1-5.5 g/L and most preferably 2-5 g/L of maltotetraose.

Preferably, the low alcohol beer contains maltose in a concentration of 0-1 g/L, more preferably of 0-0.5 g/L, and most preferably of 0.05-0.2 g/L.

The low alcohol beer preferably contains maltotriose in a concentration of 0.1-4 g/L, more preferably of 0.2-3.5 g/L, most preferably of 0.4-3 g/L.

Preferably, the low alcohol beer contains, 10-500 mg/L acetic acid, more preferably 20-300 mg/L acetic acid, and most preferably 25-200 mg/L acetic acid.

Iso-alpha acids, as well as hydrogenated alpha acids and oxidised alpha-acids (hulupones) contribute to the pleasant bitterness of beers that is appreciated by consumers. In the present process it is preferred to incorporate these hop acids in the alcoholic liquid as solubility of the hop acids in the low alcohol beer concentrate is very low. Accordingly, in a preferred embodiment, the low alcohol beer contains 0-10 mg/L, more preferably less than 3 mg/L, most preferably less than 1 mg/L hop acids selected from iso-alpha acids, hydrogenated iso-alpha acids, hulupones and combinations thereof.

In one embodiment of the present invention the low alcohol beer is produced by:
providing an alcoholic beer having an ethanol content of 3-12% ABV; and
removing ethanol from the beer, preferably by means of distillation, thereby producing a low alcohol beer and an ethanol-containing distillate.

The alcoholic beer that is used as a starting material in accordance with the aforementioned embodiment preferably has an ethanol content of 3.5-10% ABV, more preferably an ethanol content of 4-8% ABV.

The pH of the alcoholic beer, determined after degassing, is preferably in the range of 3.5 to 5.5, more preferably in the range of 3.8 to 5.2 and most preferably in the range of 4.0 to 5.0.

In a preferred embodiment, the alcoholic beer has an original extract concentration as determined by the alcolyzer method of 4-17% (m/m), more preferably of 7-15% (m/m) and most preferably of 9-14% (m/m). The original extract concentration can be determined using the Alcolyzer Beer Analyzing System of Anton Paar GmbH. The original extract, P (as % (m/m)) is calculated in the Alcolyzer program according to the Balling formula:

Original extract=100×(2.0665×A+ER)/(1.0665×A+100)
wherein:
A=Alcohol content of the beer as measured by Alcolyzer Beer Analyzing System, in % (m/m);
ER=Real extract of the beer, in % (m/m)

The real extract, ER [as % (m/m)], is calculated from the extract density at 20° C. determined by the Tabarié formula using the same Goldiner, Klemann and Kämpf table (Goldiner et al., Alkohol-, Stammwürze-und Korrektionstafel, Berlin, Institute für Gärungsgewerbe, 1996). The Tabarié formula used in the Alcolyser Beer Analyzing System is as follows:

ρ extract(20° C.)=ρ sample(20° C.)+ρ water(20° C.)−ρ alcohol(20° C.)
wherein:
ρ extract (20° C.)=density of the extract (residue) at 20° C.;
ρ sample (20° C.)=density of the sample at 20° C.;
ρ water (20° C.)=density of water at 20° C. (=0.998204 g/cm3);
ρ alcohol (20° C.)=density of the alcohol (distillate) at 20° C.;

The alcoholic beer is preferably decarbonated prior to the distillative removal of ethanol in order to avoid excessive foaming during de-alcoholisation. Preferably, the dissolved carbon dioxide content of the alcoholic beer is reduced by decarbonation to 0-4 g/L, more preferably 0-3.5 g/L, and most preferably 0-3 g/L dissolved carbon dioxide.

Removal of ethanol by distillation is preferably carried out at a temperature in the range of 10-100° C., more preferably in the range of 20-65° C., even more preferably in the range of 30-50° C., and most preferably in the range of 40-46° C.

The removal of ethanol by distillation is preferably carried out at a pressure in the range of 0.01-500 mbar, more preferably in the range of 1-200 mbar, even more preferably in the range of 5-150 mbar and most preferably in the range of 80-110 mbar.

The ethanol-containing distillate that is obtained after distillative removal of ethanol from the alcoholic beer preferably has an ethanol content of 10-80 wt. %, more preferably of 15-75 wt. % and most preferably of 20-70 wt. %.

The water content of the ethanol-containing distillate preferably is 10-87 wt. %, more preferably 15-75 wt. % and most preferably 18-60 wt. %.

Preferably, water and ethanol together constitute 85-100 wt. %, more preferably 90-100 wt. % and most preferably 95-100 wt. % of the ethanol-containing distillate.

According to a particularly preferred embodiment, the ethanol-containing distillate is applied in the alcoholic liquid that is combined with the low alcohol beer concentrate.

In one embodiment of the invention, distillative removal of ethanol from the alcoholic beer yields a distillate with a high ethanol content of 40-80 wt. %, more preferably of 45-75 wt. % and most preferably of 50-70 wt. %. This distillate may suitably be applied as such in the alcoholic liquid that is combined with the low alcohol beer concentrate.

In an alternative embodiment, distillative removal of ethanol from the alcoholic beer yields a distillate with a low ethanol content of 10-40 wt. %, more preferably of 12-35 wt. % and most preferably of 15-30 wt. %. Preferably, this distillate with a low ethanol content is concentrated to a high ethanol content of 40-80 wt. %, more preferably of 45-75 wt. % and most preferably of 50-70 wt. %, before it is applied in the alcoholic liquid. The ethanol content of the distillate with low ethanol content can suitably be increased to a concentration of 40 wt. % or more by means of distillation or membrane separation.

The ethanol-containing distillate having a high ethanol content is preferably applied in the alcoholic liquid in an amount such that the alcoholic liquid contains 60-100 wt. %, more preferably 80-100 wt. % and most preferably 90-100 wt. % of said distillate.

In an alternative embodiment of the present process the low alcohol beer is produced using a yeast fermentation with restricted formation of ethanol (e.g. cold-contact fermentation).

Cold-contact fermentation is preferably carried out at a temperature below 7° C., more preferably at −1 to 4° C., more preferably at −0.5 to 2.5° C.

Cold-contact fermentation preferably covers a period of 8-72 hours, more preferably a period of 12-48 hrs (“cold contact fermented beer”).

Another form of restricted ethanol fermentation that may be employed to produce the low alcohol beer comprises a very short (e.g. less than 2 hours) yeast fermentation at a temperature of 7° C. or more, which is followed by rapid temperature inactivation, such as by rapid cooling to −0.5 to 1° C., optionally followed by subsequent pasteurization (“arrested fermentation”).

Another form of restricted ethanol fermentation that can be used utilises a yeast strain which produces relatively low quantities of ethanol under the applied fermentation conditions, such as for example a yeast strain which produces less 0.2 g ethanol per gram fermentable sugar in the wort, preferably less than 0.1 g ethanol per gram fermentable sugar. Suitable strains (e.g. Crabtree negative strains) are known in the art, and the quantity of ethanol produced under varying fermentation conditions can be determined by routine experiments “yeast restricted beer”).

Another form of restricted ethanol fermentation that can be employed uses a first, ethanol-producing yeast strain, in the presence of a sufficient quantity of a second yeast strain which consumes virtually all of the ethanol that is produced by the ethanol-producing yeast strain. Saccharomyces rouxii is an example of a yeast strain that consumes ethanol.

Yet another form of restricted ethanol fermentation that can be utilised employs a wort having a content of fermentable sugars such that max 1.0 vol. % of alcohol is produced after completion of its fermentation. In this case, the wort generally has a content of fermentable sugars of less than 17.5 g/l, preferably less than 12 g/l, more preferably less than 8 g/I (“sugar deprived wort beer”).

Preferably, the membrane separation employed in the present process is reverse osmosis or nanofiltration. Most preferably, the present process employs reverse osmosis to remove water from the low alcohol beer.

Membrane separation of the low alcohol beer is preferably carried out at a temperature in the range of −2° C. to 40° C., more preferably in the range of 3-22° C.

The pressure employed during membrane separation is preferably in the range of 6 to 80 bare, more preferably in the range of 10 to 75 bar, and most preferably in the range of 15 to 70 bar. In a preferred embodiment, the membrane separation is carried out with a membrane having a magnesium sulphate rejection of 80-100%, more preferably 90-100% and most preferably 95-100% when measurement is carried out using 2,000 mg/L aqueous magnesium sulphate solution at 0.48 MPa, 25° C. and 15% recovery.

In a further preferred embodiment, membrane separation is carried out using a membrane with a glucose rejection of 80-100%, more preferably 90-100% and most preferably 95-100% when measurement is carried out using 2,000 mg/L aqueous glucose solution at 1.6 MPa, 25° C. and 15% recovery.

According to a particularly preferred embodiment, membrane separation is carried out by means of reverse osmosis or forward osmosis using a membrane with a sodium chloride rejection of 80-100%, more preferably 90-100% and most preferably 95-100% when measurement is carried out using 2000 mg/L sodium chloride solution at 10.3 bar, 25° C., pH 8 and 15% recovery.

Reduction of the water content of the low alcohol beer by means of membrane separation is hampered by the presence of significant quantities of dissolved carbon dioxide in the low alcohol beer. Accordingly, it is preferred to employ a low alcohol beer containing 0-500 mg/L, more preferably 0-100 mg/L, and most preferably 0-20 mg/L dissolved carbon dioxide.

In a preferred embodiment, the water content of the low alcohol beer is reduced by membrane filtration by at least 70%, more preferably by at least 75%, and most preferably by at least 80%.

The low alcohol beer concentrate that is obtained as an intermediate product in the present process preferably is a liquid.

The ethanol content of the low alcohol beer concentrate that is produced in the present process, preferably does not exceed 1.0% ABV, more preferably it does not exceed 0.5% ABV, even more preferably it does not exceed 0.3% ABV, most preferably it does not exceed 0.1% ABV.

The pH of the low alcohol beer concentrate is preferably in the range of 3.0 to 6.0, more preferably in the range of 3.2 to 5.5 and most preferably in the range of 3.5 to 5.0.

The low alcohol beer concentrate preferably has a water content in the range of 35-80 wt. %, more preferably in the range of 40-75 wt. % and most preferably in the range of 45-70 wt. %.

In a preferred embodiment, the low alcohol beer concentrate has a density of 20 to 60° P, more preferably a density of 24 to 50° P, and most preferably a density of 28 to 42° P.

Riboflavin, free fatty acids (e.g. linoleic acid), amino acids and small peptides are substances that are naturally present in malted barley and that typically occur in significant concentrations in low alcohol beer. Likewise, maltotetraose is found in significant concentrations in low alcohol beer as this oligosaccharide is formed by enzymatic hydrolysis of starch during mashing and is not digested by yeast. Due to the fact that the low alcohol beer concentrate in the capsule is obtained from low alcohol beer using a concentration method that only removes water, or only water and low molecular weight substances and ions, the low alcohol beer concentrate typically contains appreciable levels of riboflavin, linoleic acid, amino acids, peptides and/or maltotetraose.

The riboflavin content of the low alcohol beer concentrate is preferably in the range of 250-3,000 mg/L more preferably 300-2,500 μg/L, more preferably 350-2,200 μg/L and most preferably 400-2,000 μg/L.

The low alcohol beer concentrate preferably contain 150-5,000 μg/L, more preferably 200-4,000 μg/L, even more preferably 250-3,500 μg/L and most preferably 300-3,000 μg/L of linoleic acid.

Besides linoleic acid, the liquid beer concentration typically also contains other fatty acids, such as oleic acid and/or alpha-linolenic acids. Oleic acid is preferably present in the low alcohol beer concentrate in a concentration of 300-3,000 μg/L, more preferably 400-2,500 μg/L, even more preferably 500-2,000 μg/L and most preferably 600-1,800 μg/L.

Alpha-linolenic acid is preferably present in the low alcohol beer concentrate in a concentration of 100-1,200 μg/L, more preferably 120-1,100 μg/L, even more preferably 150-1,000 μg/L and most preferably 180-900 μg/L.

The free amino nitrogen (FAN) content of the low alcohol beer concentrate is preferably in the range of 60-1,000 mg/L more preferably 80-800 mg/L, even more preferably 90-700 mg/L and most preferably 100-600 mg/L.

The low alcohol beer concentrate preferably contains 10-100 g/L, more preferably 12-80 g/L, even more preferably 15-60 and most preferably 18-40 g/L of maltotetraose.

Preferably, the low alcohol beer concentrate contains maltose in a concentration of 0-20 g/L, more preferably of 0-15 g/L, even more preferably of 0.5-10 g/L and most preferably of 1-8 g/L.

The low alcohol beer concentrate preferably contains maltotriose in a concentration of 1-30 g/L, more preferably of 2-25 g/L, even more preferably of 2.5-22 g/L and most preferably of 3-20 g/L.

Preferably, the low alcohol beer concentrate contains, 100-1,200 mg/L acetic acid, more preferably 120-1,000 mg/L acetic acid, even more preferably 150-900 mg/L acetic acid and most preferably 180-800 mg/L acetic acid.

The low alcohol beer concentrate may suitably be combined with one or more other components, besides the alcoholic liquid, before it is packaged.

Preferably, water and ethanol together constitute 85-100 wt. %, more preferably 90-100 wt. % and most preferably 95-100 wt. % of the alcoholic liquid.

The alcoholic liquid that is combined with the low alcohol beer concentrate in the present method preferably contains appreciable levels of beer flavour volatiles (e.g. ethyl acetate, isoamyl acetate, phenylethyl acetate, amyl alcohols and phenylethyl alcohol) that originate from the alcoholic beer.

Preferably, the alcoholic liquid comprises, per kg of ethanol, 50-2,000 mg, more preferably 70-1,500 mg, even more preferably 90-1,200 mg and most preferably 100-800 mg of ethyl acetate.

Preferably, the alcoholic liquid comprises, per kg of ethanol, 5-200 mg, more preferably 7-150 mg, even more preferably 9-120 mg and most preferably 10-80 mg of isoamyl acetate.

In a preferred embodiment the alcoholic liquid contains, per kg of ethanol, 400-5,000 mg, more preferably 600-4,000 mg, even more preferably 700-3,500 mg and most preferably 800-3.00 mg of amyl alcohols. Here the term “amyl alcohols” refers to alcohols with the formula C₅H₁₂O.

In another preferred embodiment the alcoholic liquid contains, per kg of ethanol, 8-240 mg, more preferably 11-170 mg, even more preferably 13-140 mg and most preferably 15-100 mg of phenylethyl alcohol.

Preferably, the alcoholic liquid contains, per kg of ethanol, 2-50 mg, more preferably 3-40 mg, even more preferably 3.5-32 mg and most preferably 4-25 mg of phenyl ethyl acetate.

As already mentioned above, in a preferred embodiment, prior to the combining with the low alcohol beer concentrate, the alcoholic liquid is combined with hop acids selected from iso-alpha acids, hydrogenated iso-alpha acids, hulupones and combinations thereof. More preferably, the alcoholic liquid is combined with iso-alpha acids. Iso-alpha acids may suitably be provided in the form of pre-isomerised hop extract.

Preferably, hop acids are added to the alcoholic liquid to achieve a concentration of 50-2,000 mg/L, more preferably 100-1,500 mg/L, most preferably 200-1,000 mg/L.

Flavouring is an example of a component that may suitably be added to the alcoholic liquid and/or the low alcohol beer concentrate before they are combined, and/or to the alcoholic beer concentrate.

According to a particularly preferred embodiment, the present process comprises mixing of the low alcohol beer concentrate with the alcoholic liquid.

In the present process, the low alcohol beer concentrate and the alcoholic liquid are preferably combined in a weight ratio of 7:1 to 1:1, more preferably in a weight ratio of 6:1 to 1.2:1, most preferably in a weight ratio of 5:1 to 1.5:1.

The liquid alcoholic beer concentrate that is obtained by the present process preferably has an ethanol content of 10-60 wt. %, more preferably of 15-50 wt. % and most preferably of 20-40 wt. %.

The liquid alcoholic beer concentrate that is obtained by combining the low alcohol beer concentrate with the alcoholic liquid and the optional additional source of ethanol is preferably packaged in a container or a single-serve capsule The single serve capsule is preferably filled with 12-70 mL, more preferably 15-65 mL, most 20-60 mL of the liquid alcoholic beer concentrate.

The container is preferably filled with 250-3,000 m mL, more preferably 400-2,000 mL, most 500-1,500 mL of the liquid alcoholic beer concentrate.

Another aspect of the invention relates to an alcoholic beer concentrate that is obtained by the present process.

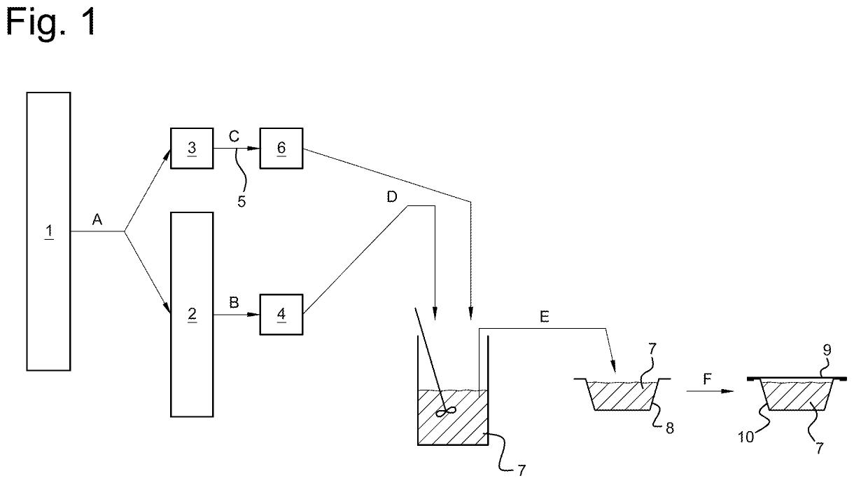

FIG. 1 provides a schematic representation of a method of preparing a single-serve capsule containing the liquid alcoholic beer concentrate according to the invention, starting from a non-hopped alcoholic beer (1). Step A of the depicted method comprises de-alcoholisation of the non-hopped alcoholic beer (1) to produce a non-alcoholic beer (2) and an alcoholic liquid (3). Step B comprises concentration of the non-alcoholic beer (2) by means of reverse osmosis to produce a low alcohol concentrate (4). Step C comprises mixing of pre-isomerised hop extract (5) with the alcoholic liquid (3) to produce an alcoholic liquid containing dissolved hop acids (6). Step D comprises mixing of the low alcohol beer concentrate (4) with the alcoholic liquid containing dissolved hop acids (6), thereby producing a liquid alcoholic beer concentrate (7). Step E comprises the filling of a single serve capsule (8) with the liquid alcoholic beer concentrate (7). Step F comprising the sealing of the single serve capsule with a seal (9) to produce a sealed single serve capsule (10) containing the liquid alcoholic beer concentrate (7).

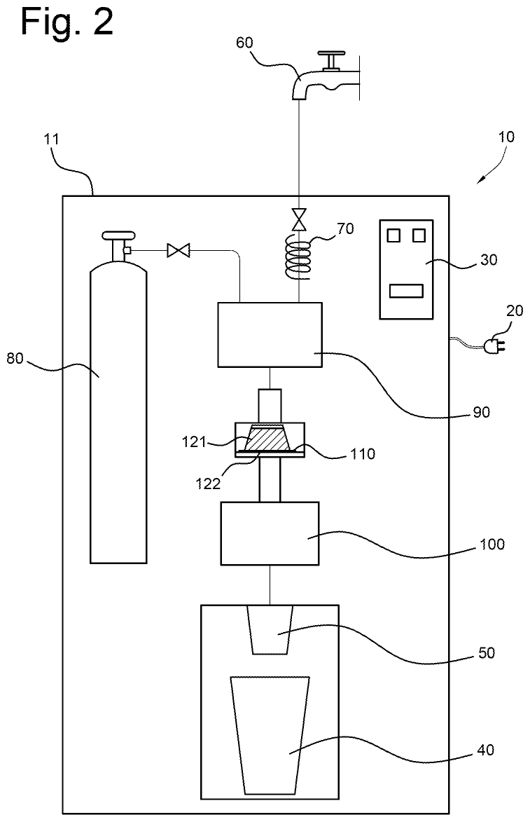

FIG. 2 shows a representation of a device (10) for preparing a reconstituted beer. The device includes a housing (11) which houses the mechanical and electronic components of the device (10). The housing (11) can be formed of plastic and/or metal.

The device (10) comprises a power supply (20) and a control system (30) operable to activate the device and control functions of the device (e.g. the volume, temperature and/or alcohol content of the dispensed reconstituted beer). Also shown is an empty glass (40) that is positioned underneath the dispensing unit (50).

The device (10) also includes a source of water in the form of a water tap (60) and a cooling unit (70). The device (10) further comprises a cylinder (80) containing pressurised carbon dioxide, a carbonation unit (90), a mixing unit (100) and a receptacle (110) for receiving a two-compartment single serve capsule (120).

The single serve capsule (120) contains a liquid alcoholic beer concentrate (121). The single serve capsule (120) is sealed by a foil (122).

The device (10) comprises means for opening the single serve capsule (120).

In use, a consumer can place the single serve capsule (120) in the receptacle (110) of the device (10). Next, the consumer can activate the device (10) using the control system (30) and await dispensing of the reconstituted beer from the dispensing unit (50) into the glass (40).

Upon activation of the device (10) water from the tap (60) and pressurized carbon dioxide from the cylinder (80) are dispensed to the carbonation unit (90). During its passage to the carbonation unit (90) the water is cooled by the cooling unit (70). Once the adequate amounts of water and carbon dioxide have been mixed in the carbonation unit (90), the carbonated is released from the carbonation unit (90) and flows through the single serve capsule (120) to the mixing unit (100).

While passing through the single serve capsule (120), the carbonated water washes out the liquid alcoholic beer concentrate (121) into the mixing unit (100). In the mixing unit (100) the carbonated water and the washed out liquid alcoholic beer concentrate are intimately mixed to produce a clear reconstituted beer.

Next the clear reconstituted beer is released from the mixing unit (100) through the dispensing unit (50) into glass (40) under the formation of a foam head.

The invention is further illustrated by the following non-limiting examples.

### EXAMPLES

### Example 1

A non-hopped lager (containing 5% ABV was de-alcoholised by vacuum distillation (Schmidt-Bretten, Bretten, Germany—feed: 5 hL/hr; steam mass flow rate: 100 kg/h; outlet pressure: 3.5 bar; vacuum setting: 90 mbar; outlet temperature: 3° C.). The resulting de-alcoholised beer had an ethanol content of 0.01% ABV.

Distillate produced during de-alcoholisation was recovered and analysed. The results are shown in Table 1.

TABLE 1

| | | |
|---|---|---|
| Ethanol | 60 | wt. % |
| Ethyl acetate | 50.2 | mg/L |
| Isoamyl acetate | 4.56 | mg/L |
| Amyl alcohols | 206 | mg/L |
| Phenylethyl alcohol | 5.09 | mg/L |
| Phenyl ethyl acetate | 2.77 | mg/L |

The dealcoholized non-hopped lager was concentrated by means of nanofiltration using the following set-up:

Nanofiltration membrane

| | |
|---|---|
| Type | Configuration: Spiral wound |
| | Membrane polymer: Composite polyamide |
| | Brine spacer material: Polypropylene |
| Specifications | Permeate Flow: |
| | MgSO4: 7.6 m3/d |
| | NaCl: 9.5 m3/d |
| | Stabilised salt rejection1: |
| | MgSO4: >97% (2000 ppm, 4.8 bar, 25° C., |
| | 15% recovery, pH 6.5) |
| | NaCl: 89-95% (500 ppm, 4.8 bar, 25° C., |
| | 15% recovery, pH 7.0) |
| | Nominal membrane area: 7.9 m2 1 |
| | Equates to a MW cut-off of appr. 200 Da |

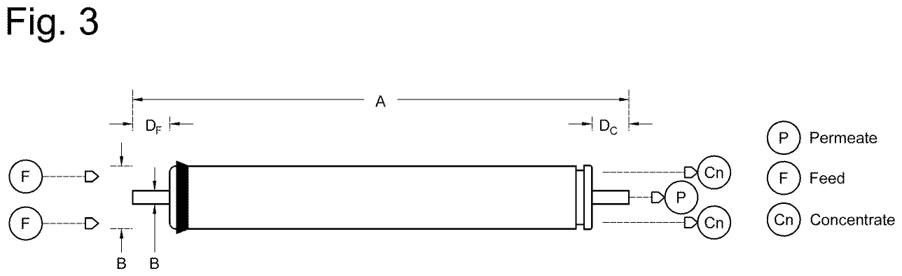

The configuration of the nanofiltration device that was used is shown in FIG. 3. The dimensions of the depicted device were as follows:

| | | |
|---|---|---|
| A (total length)= | 1016 | mm |
| B (ATD diameter)= | 100.3 | mm |
| C (connection diameter)= | 19.1 | mm |
| DF (core tube extension - feed side)= | 26.7 | mm |
| DC (core tube extension - conc. side)= | 26.7 | mm |

### Maximum Operating Limits

Pressure: 80 bar
Temperature: 28° C.
Pressure drop: 0.7 bar
Feed flow: 3.6 m3/h
Chlorine concentration: <0.1 ppm
Feed water SDI (15 min.): 5.0
Feed water turbidity: 1.0 NTU
Feed water pH: 3.0-10.0
Maximum ratio of concentrate to permeate flow for any element: 5:1

### Filtration Run

Circulation of the beer was effected by a piston pump. This pump has a capacity of 1 m3/h and a maximum discharge pressure of 20-80 bar. The test-unit was limited to approximately bar and was protected by means of an overpressure relief valve having a set-point of 40 bar.

Initial permeate production started at a pressure of around 15 bar (osmotic pressure).

In total 100 litres of beer were filtered, yielding 84.6 litres of permeate and 16.1 litres of liquid concentrate. Consequently, the concentration factor achieved was 100/15.4=6.5.

The composition of the beer concentrate so obtained is shown in Table 2.

TABLE 2

| | | |
|---|---|---|
| Acetic acid | 310 | mg/L |
| Riboflavin | 890 | μg/L |
| Oleic acid | 1040 | μg/L |
| Linoleic acid | 980 | μg/L |
| Alpha-linolenic acid | 630 | μg/L |
| Free amino nitrogen | 310 | mg/L |
| Maltose | 1.1 | g/L |
| Maltotriose | 7.0 | g/L |
| Maltotetraose | 22 | g/L |

### Comparative Example A

A commercial hopped lager beer having an alcohol content of 5.0% ABV and iso-alpha acids content of 19 mg/L was concentrated by means of nanofiltration using the same set-up as in Example 1.

Initial permeate production started at a pressure of around 4 bar (osmotic pressure). In total 200 litres of beer were filtered, yielding 172.3 litres of permeate and 27.7 litres of concentrate. Consequently, the concentration factor achieved was 200/27.7=7.2.

The hopped, alcoholic beer concentrate so obtained was cloudy, had an ethanol content of 4.71% ABV, a specific gravity of 1.8298 (20° P). The concentrate contained 78.7 mg/L iso-alpha acids, meaning that 42.5% of the iso-alpha acids were lost during the nanofiltration step.

### Example 2

A liquid beer concentrate containing virtually no alcohol was prepared as in Example 1. In addition, an alcoholic liquid containing 210 mg/L iso-alpha acids was prepared by mixing a pre-isomerised hop extract containing 30 wt. % iso-alpha acids (Isohop, ex Barth Haas) with 95% ethanol.

Two alcoholic beer concentrates were prepared:
Beer concentrate I, containing 55 mg/L iso-alpha acids, was prepared by mixing 32 mL of liquid beer concentrate with 11.4 mL of the iso-alpha acid containing alcoholic liquid.
Beer concentrate II, also containing 55 mg/L iso-alpha acids, was prepared mixing 32 mL of liquid beer concentrate with the aforementioned pre-isomerised hop extract followed by mixing, and then adding 11.4 mL of 95% ethanol, again followed by mixing.

Both beer concentrates were stored at room temperature for several days before being mixed with 150 mL of carbonated water (Royal Club Soda Water), resulting in reconstituted beer I and reconstituted beer II, respectively.

Reconstituted beer I was clear, and had a nice foam head and a nice bitter taste. Reconstituted beer II had a nice foam head and a mild bitter taste (less strong than reconstituted beer I), and was found to contain some sediment.

### Example 3

A single serve capsule containing a liquid alcoholic beer concentrate according to the invention is prepared as follows:

The alcoholic distillate of Example 1 is mixed with a pre-isomerised hop extract to produce a solution containing 210 mg/L iso-alpha acids.

The alcoholic distillate containing added hop extract is mixed with the liquid beer concentrate of Example 1 in a volume ratio of 18:32 to produce a liquid alcoholic beer concentrate. 50 mL of this liquid alcoholic beer concentrate is filled into capsule with an internal volume of 55 mL, following which the capsule is sealed with a flexible foil.

The liquid alcoholic beer concentrate does not exhibit haze formation.

### Example 4

The liquid alcoholic beer concentrate of Example 3 is combined with 150 mL of carbonated water to produce a reconstituted beer having a temperature of 5° C.

The reconstituted beer so obtained is clear (i.e. not hazy) and has the typical yellow colour of a lager, as well as satisfactory foam properties.

The evaluation of the reconstituted beer by an expert panel shows that this beer has a pleasant taste similar to that of ordinary lagers.

1. A process of manufacturing a liquid alcoholic beer concentrate, the process comprising obtaining a low alcohol beer having an ethanol content of 0-1% ABV, a free amino nitrogen content of 8-400 mg/L and having 0.1-4 g/L maltotriose and 0.5-6 g/L of maltotetraose by:
(i) obtaining an alcoholic beer having an ethanol content of 3-12% ABV and an original extract of 7-14% (m/m); and
(ii) removing ethanol from the beer by means of distillation at a temperature between 20-65° C. and a pressure between 1-200 mbar to produce a low alcohol beer and an ethanol-containing distillate;
(iii) removing at least 70 wt. % of the water present in the low alcohol beer by membrane separation employing a pressure between 6 to 80 bars to produce a low alcohol beer concentrate, wherein the membrane separation is selected from nanofiltration, reverse osmosis and forward osmosis and using a membrane with a glucose rejection of 80-100% when measured using 2,000 mg/L aqueous glucose solution at 1.6 MPa, 25° C. and 15% recovery;
(iv) combining 1 to 5 parts by weight of the low alcohol beer concentrate with 1 part by weight of alcoholic liquid having an ethanol content of at least 30 wt. % to produce a liquid alcoholic beer concentrate having an ethanol content of 10-60 wt. %;
wherein the distillative removal of ethanol either yields a distillate with an ethanol content of 40-80 wt. % or a distillate with an ethanol content of 10-40 wt. % which is further concentrated to an ethanol content of 40-80 wt. %, and
wherein the ethanol-containing distillate having an ethanol content of 40-80 wt. % is applied in the alcoholic liquid in an amount such that the alcoholic liquid contains 60-100 wt. % of the distillate.

2. The process according to claim 1, wherein the low alcohol beer comprises 1-5.5 g/L maltotetraose.

3. The process according to claim 2, wherein the low alcohol beer comprises 2-5 g/L maltotetraose.

4. The process according to claim 1, wherein the low alcohol beer comprises 0.2-3.5 g/L maltotriose.

5. The process according to claim 4, wherein the low alcohol beer comprises 0.4-3 g/L maltotriose.

6. The process according to claim 1, wherein the low alcohol beer is produced using a yeast fermentation with restricted formation of ethanol.

7. The process according to claim 1, wherein the ethanol content of the low alcohol beer does not exceed 0.5% ABV.

8. The process according to claim 7, wherein the ethanol content of the low alcohol beer does not exceed 0.3% ABV.

9. The process according to claim 1, wherein membrane separation is carried out using a membrane with a sodium chloride rejection of 80-100% when measured using 2000 mg/L sodium chloride solution at 10.3 bar, 25° C., pH 8 and 15% recovery.

10. The process according to claim 9, wherein membrane separation is carried out using a membrane with a sodium chloride rejection of 90-100% when measured using 2000 mg/L sodium chloride solution at 10.3 bar, 25° C., pH 8 and 15% recovery.

11. The process according to claim 1, wherein membrane separation is carried out at a pressure of 10-75 bar.

12. The process according to claim 11, wherein membrane separation is carried out at a pressure of 15-70 bar.

13. The process according to claim 1, wherein water is removed from the low alcohol beer by reverse osmosis.

14. The process according to claim 1, wherein the low alcohol beer comprises 0-10 mg/L of hop acids selected from iso-alpha acids, hydrogenated iso-alpha acids, hulupones and combinations thereof.

15. The process according to claim 1, wherein the alcoholic liquid comprises hop acids in a concentration of 50-2,000 mg/L, the hop acids being selected from iso-alpha acids, hydrogenated iso-alpha acids, hulupones and combinations thereof.

16. The process according to claim 1, wherein the low alcohol beer concentrate and the alcoholic liquid are combined in a weight ratio of 7:1 to 1:1.

17. The process according to claim 1, wherein the low alcohol beer concentrate comprises 250-3,000 μg/L of riboflavin.

18. The process according to claim 1, wherein the alcoholic liquid comprises, per kg of ethanol, 50-2,000 mg of ethyl acetate.

19. The process according to claim 1, further comprising filling the liquid alcoholic beer concentrate is into a single-serve capsule or a container.

20. A liquid alcoholic beer concentrate obtained by a process according to claim 1.
